(19) United States
(12) Patent Application Publication
(10) Pub. No.: US 2008/0123333 A1
(43) Pub. Date: May 29, 2008

(54) Alarm light device

(76) Inventors: Meng-Tien Lee, Taipei-Hsien (TW); Meng-Yuan Lee, (US)

Correspondence Address: MENG-TIEN LEE, 235 Chung-Ho, Box 8-24, Taipei, omitted

(21) Appl. No.: 11/591,858

(22) Filed: Nov. 3, 2006

(51) Int. Cl. F21V 7/00

(52) U.S. Cl. 362/247; 362/282

(57) ABSTRACT

An alarm light device comprises a casing seat having a power wire passing through a lower side thereof; a base installed on the casing seat; a bottom of the base being installed with a motor; a rotary shaft of the motor passing through the base to be protruded from an upper side of the base; a driven gear installed around the rotary shaft and a driven gear being installed in the case and being engaged to the driving gear; a rotary seat being installed on the driven gear; at least one reflector cambered mirror being installed on the rotary shaft; a center portion of the rotary seat having a through hole; a lamp seat installed in the through hole; at least one first strong power source being installed in the lamp seat; and a cover covering upon the base so as to form an alarm light.

### FIELD OF THE INVENTION

The present invention relates to alarm lights, and particularly to an alarm light device installed with a strong power source so that the alarm light device has a longer lifetime, great illumination, less power consumption and is economic.

### BACKGROUND OF THE INVENTION

Referring to FIG. 1, a prior art alarm light 1 is illustrated. The alarm light 1 has a casing seat 10. The casing seat 10 is installed with a base 11. A bottom of the base 11 has a motor 12. The rotary shaft 120 of the motor 12 passes through the base 11 to protrude from an upper side thereof. The rotary shaft is installed with a driving gear 121. A driven gear is installed on the base and is engaged to the driving gear 121. A rotary seat 14 is installed on the driven gear 13. A reflector cambered mirror 15 is installed on the rotary seat 14. A center portion of the rotary seat 14 has a through hole 140. A lamp seat 16 is installed in the through hole 140. A bubble 17 is installed in the lamp seat 16. A transparent cover 16 is installed on the base 11. A lower side of the casing seat 10 is installed with a power wire 19. Thus, when the power wire 19 is conducted, the bubble 17 will light up and the motor 12 actuates to drive the driving gear 121 to rotate and then drive the driven gear 13 to rotate. The driven gear 13 will drive the rotary seat 14 and the reflector cambered mirror 15 to rotate. The reflector cambered mirror 15 reflects light from the bubble 17 and then transmits through the cover 18. By rotation of the reflector cambered mirror 15, the light will flash so as to have the effect of alert. However, the bubble 17 in the prior art has power consumed and has a short lifetime. The bubble 17 must be replaced frequently. The illumination of the bubble 17 will reduce after being used for a long time.

### SUMMARY OF THE INVENTION

Accordingly, the primary object of the present invention is to provide an alarm light device with a longer lifetime, great illumination, less power consumption and being economic.

To achieve above objects, the present invention provides an alarm light device which comprises a casing seat having a power wire passing through a lower side thereof; a base installed on the casing seat; a bottom of the base being installed with a motor; a rotary shaft of the motor passing through the base to be protruded from an upper side of the base; a driven gear installed around the rotary shaft and a driven gear being installed in the case and being engaged to the driving gear; a rotary seat being installed on the driven gear; at least one reflector cambered mirror being installed on the rotary shaft; a center portion of the rotary seat having a through hole; a lamp seat installed in the through hole; at least one first strong power source being installed in the lamp seat; and a cover covering upon the base so as to form an alarm light.

The various objects and advantages of the present invention will be more readily understood from the following detailed description when read in conjunction with the appended drawing.

### BRIEF DESCRIPTION OF THE DRAWINGS

FIG. 1 is a perspective view of a prior art.

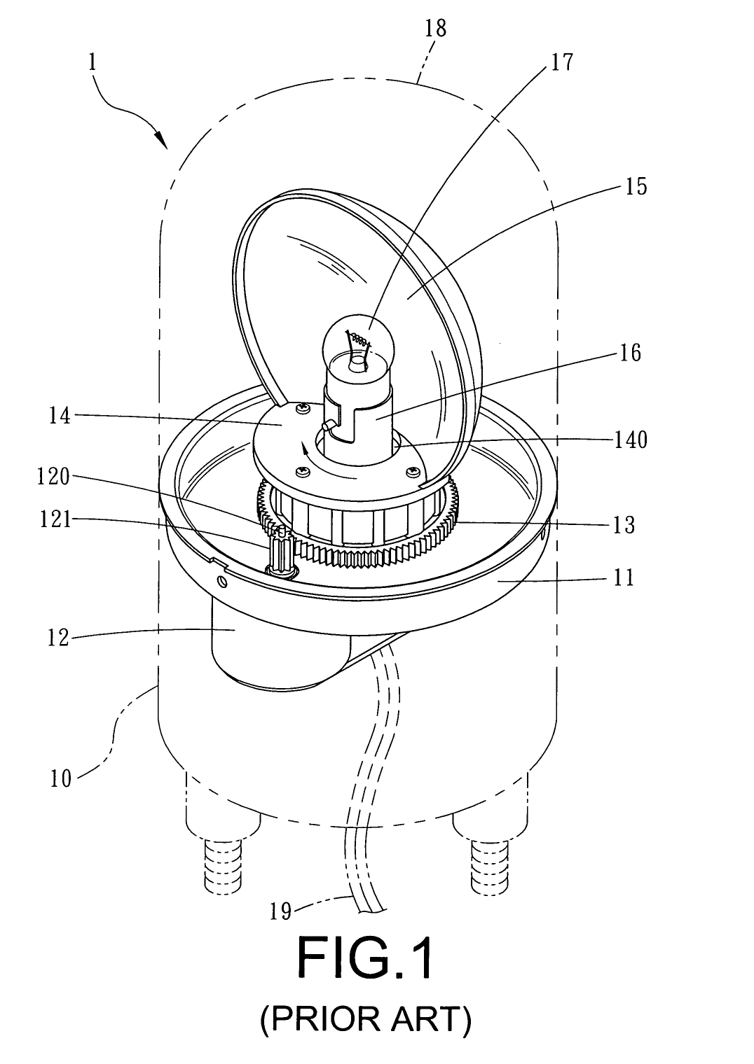

FIG. 2 is a perspective view of the present invention.

FIG. 3 is a perspective view of another embodiment of the present invention.

FIG. 4 is a perspective view of a further embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

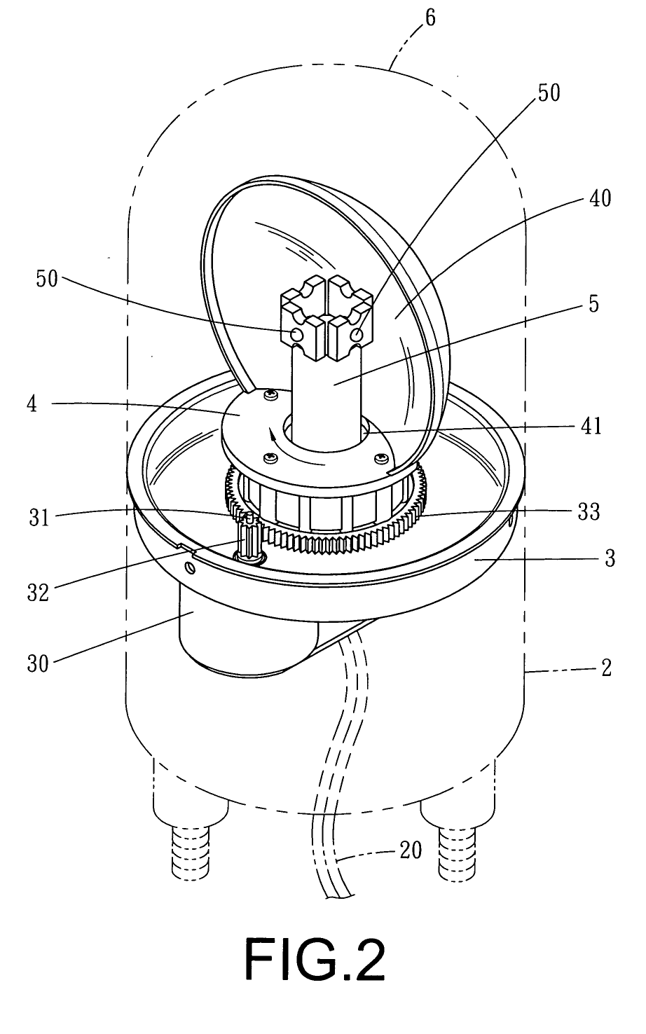

Referring to FIG. 2, the structure of the present invention is illustrated. The present invention has the following elements.

A casing seat 2 has a power wire 20 passing through a lower side thereof.

A base 3 is installed on the casing seat 2. A bottom of the base 3 is installed with a motor 30. A rotary shaft 31 of the motor 30 passes through the base 3 and being protruded from an upper side of the base 3.

A driven gear 33 is installed on the rotary shaft 31 and a driven gear 33 is installed in the case 3 and is engaged to the driving gear 32. A rotary seat 4 is installed on the driven gear 33. At least one reflector cambered mirror 40 is installed on the rotary shaft 31. A center portion of the rotary seat 4 has a through hole 41.

A lamp seat 5 is installed in the through hole 41. At least one strong power source 50 is installed in the lamp seat 5. The strong power source 50 is formed by a plurality of light emitting elements, such as light emitting diodes.

A cover 6 covers upon the base 3 so as to form an alarm light.

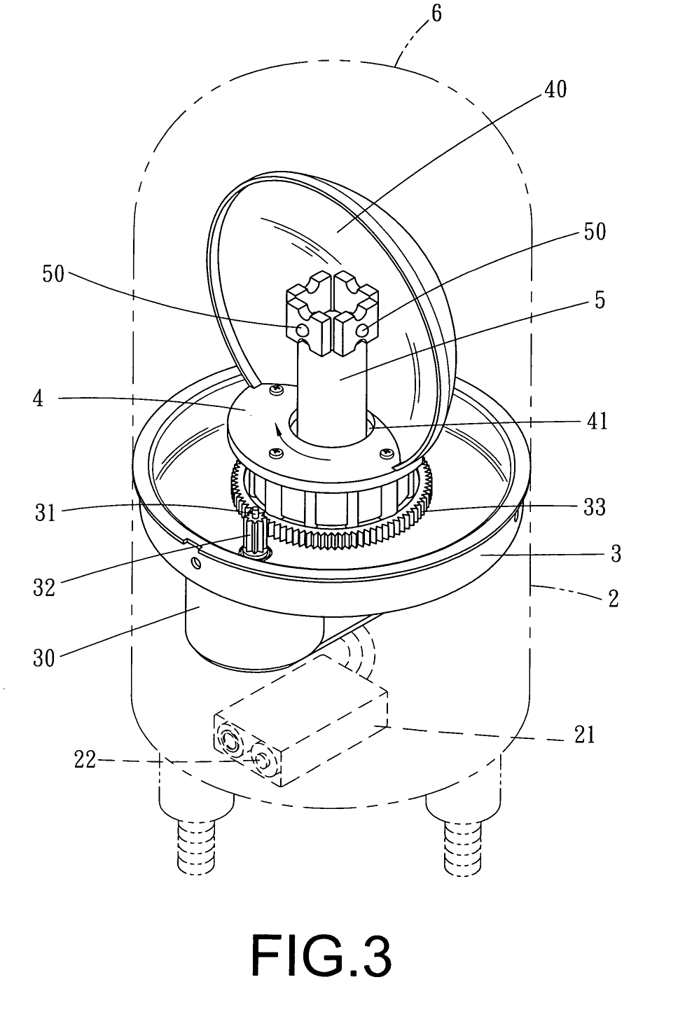

Referring to FIG. 3, a battery seat 21 is installed in the casing seat 2 for receiving a battery 22 which is used as a power source of the strong power source 50 and the motor 30.

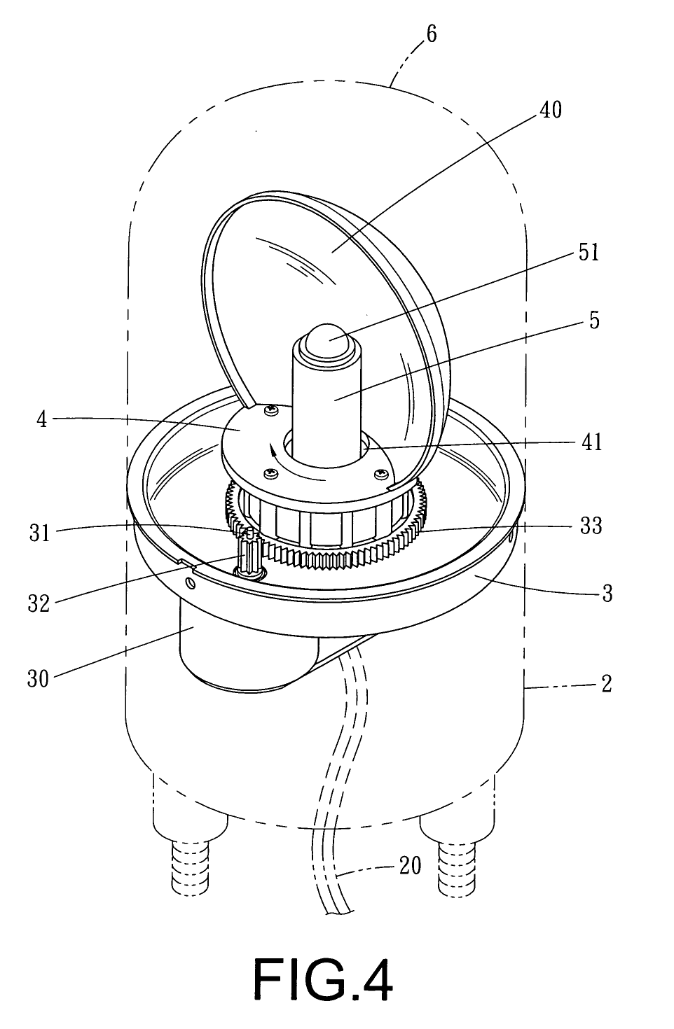

Referring to FIG. 4, the lamp seat 5 can be installed with another strong power source 51 which is formed by only one light emitting element, such as one light emitting diode. The light of the strong power source 51 is used for alert.

Referring to FIGS. 2 to 4, the application of the present invention is illustrated. The motor 30 is actuated by the power from the battery 22 or a power wire 20. The rotary shaft 31 of the motor 30 will drive the driving gear 32 to rotate and thus to drive the driven gear 33 to rotate. The driven gear 33 will drive the rotary seat 4 and the reflector cambered mirror 40 to rotate therewith. The reflector cambered mirror 40 serves to reflect the light from the strong power source 50 or strong power source 51 and then projects out through the cover 6. The rotation of the reflector cambered mirror 40 will make the light from the strong power source 50 or strong power source 51 flash so as to have the effect of alert. The strong power source 50 and strong power source 51 will prolong the lifetime of the alarm light. The power of the strong power source 50 of strong power source 51 is low and the strong power source 50 and strong power source 51 have preferred illumination so as to have preferred alarm effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An alarm light device, comprising:
a casing seat having a power wire passing through a lower side thereof;
a base installed on the casing seat; a bottom of the base being installed with a motor; a rotary shaft of the motor passing through the base to be protruded from an upper side of the base;
a driven gear installed around the rotary shaft and a driven gear being installed in the case and being engaged to the driving gear; a rotary seat being installed on the driven gear; at least one reflector cambered mirror being installed on the rotary shaft; a center portion of the rotary seat having a through hole;
a lamp seat installed in the through hole;
at least one first strong power source being installed in the lamp seat; and
a cover covering upon the base so as to form an alarm light.

2. The alarm light device as claimed in claim 1, wherein a battery seat is installed in the casing seat for receiving a battery which is used as a power source of the strong power source and the motor.

3. The alarm light device as claimed in claim 1, wherein the first strong power source is a plurality of light emitting elements.

4. The alarm light device as claimed in claim 3, wherein the plurality of light emitting elements are light emitting diodes.

5. The alarm light device as claimed in claim 1, wherein the first strong power source is one light emitting element.

6. The alarm light device as claimed in claim 5, wherein the light emitting element is a light emitting diode.
